(19) United States
(12) Patent Application Publication
(10) Pub. No.: US 2007/0204001 A1
(43) Pub. Date: Aug. 30, 2007

(54) Method of evaluating documents

(76) Inventors: John M. Hoopes, Washington, IL (US); Pauline C. Agbodjan-Prince, Peoria, IL (US); Douglas C. Meyer, Morton, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/363,093

(22) Filed: Feb. 28, 2006

(51) Int. Cl. G06F 15/16

(52) U.S. Cl. 709/217

(57) ABSTRACT

A method of evaluating at least one document. The method includes compiling first data indicative of a first document that includes a plurality of first data fields. The method also includes receiving second data indicative of a first criteria that includes at least one of a quantity of first data fields to evaluate or a degree of required similarity with respect to a first data field to establish a match. The method also includes performing a first- query as a function of the first criteria with respect to a first database. The first database is populated with third data indicative of a plurality of second documents that each include a plurality of second data fields. The method also includes establishing fourth data indicative of a listing of second documents as a function of the second data fields associated with one second document that substantially match a respective first data field of the first document. The method further includes identifying as a function of the hierarchy at least one of the plurality of second documents to be further evaluated with respect to at least one second data field associated with the identified second document.

### TECHNICAL FIELD

The present disclosure relates to a method of evaluating and, more particularly, to a method of evaluating documents.

### BACKGROUND

Systems for procuring products, such as, for example, goods or services, often include many documents that are transferred between entities, e.g., purchasers, suppliers, and/or receivers, as the goods are manufactured, shipped, received, used, billed, and purchased. Typical documents include, for example, purchase orders, invoices, schedules, shipping notices, packing lists, and/or warehouse receipts, and are usually hardcopy paper documents. Additionally, such documents usually include a plurality of data such as, for example, product numbers, supplier names or numbers, product descriptions, quantities, delivery dates, and/or other data known in the art. Often, one or more documents associated with a single system for procuring products contain data which do not match respective data of at least one other document of the same system. For example, an invoice indicating a certain quantity of products may not be matched with a warehouse receipt for the same quantity. Unmatched documents are evaluated and resolved before an accounts payable department pays a supplier and often delay payment to the supplier, require resources to resolve, and/or strain business relationships between suppliers and purchasers.

U.S. Patent Application Publication No. 2003/0195836 (“the '836 application”) issued to Hayes et al. discloses a method and system for approximate matching of data records. The method of the '836 application includes querying for a matching purchase order with respect to an invoice and, if a matching purchase order is found, automatically processing the purchase order and invoice. If a matching purchase order is not found, the method of the '836 application includes determining if a single best fit match is found and, if so, determining if the best fit match is within allowable thresholds. If the best fit match is within allowable thresholds, the method of the '836 method includes automatically correcting the invoice to match the purchase order and automatically processing the purchase order and invoice. If a single best fit match is not found or if the single best fit match is not within allowable thresholds, the method of the '836 application includes sending ranked approximate matches to an operator for processing. The method of the '836 application queries a database of purchase orders by comparing each of a plurality of data fields of an invoice with respective data fields of a plurality of purchase orders and determines a rank of a particular purchase order as a function of the closeness of a match between compared data fields and an assigned weight associated with the data fields.

Although the method of the '836 application may rank approximate matched purchase orders with respect to an invoice, each data field may be evaluated for potential matching. As such, the '836 application may perform unnecessary comparisons and/or searches. Additionally, the method of the '836 application may require a complex weighting procedure with respect to data fields to determine the rank of approximate matches.

The present disclosure is directed to overcoming one or more of the shortcomings set forth above.

### SUMMARY OF THE INVENTION

In one aspect, the present disclosure is directed to a method for evaluating at least one document. The method includes compiling first data indicative of a first document that includes a plurality of first data fields. The method also includes receiving second data indicative of a first criteria that includes at least one of a quantity of first data fields to evaluate or a degree of required similarity with respect to a first data field to establish a match. The method also includes performing a first query as a function of the first criteria with respect to a first database. The first database is populated with third data indicative of a plurality of second documents that each include a plurality of second data fields. The method also includes establishing fourth data indicative of a listing of second documents as a function of the second data fields associated with one second document that substantially match a respective first data field of the first document. The method further includes identifying as a function of the hierarchy at least one of the plurality of second documents to be further evaluated with respect to at least one second data field associated with the identified second document.

In another aspect, the present disclosure is directed to a work environment for evaluating a first document having a plurality of first data fields with respect to a plurality of second documents each having at plurality of second data fields. The work environment includes a computer configured to receive inputs from at least one user, a database populated with first data indicative of the plurality of second documents, and a program. The program is configured to receive a first input indicative of the first document and a second input indicative of a first query. The first query includes criteria configured to identify at least one first data field and a similarity threshold for the identified first data field. The program is also configured to perform at least one first algorithm as a function of the received first query. The first algorithm is configured to access at least a portion of the first data to identify a subset of the plurality of second documents. Each second document of the subset includes at least one data field that is substantially similar to at least one data field of the first document. The program is also configured to perform at least one second algorithm configured to establish the subset in a listing as a function of the second data fields each second document includes that substantially match respective first data fields.

In yet another aspect, the present disclosure is directed to a method of matching an invoice having a plurality of data fields with a warehouse receipt having a plurality of data fields. The method includes compiling first data indicative of at least one invoice that includes at least one data field that does not substantially match a respective data field of at least one of a plurality of warehouse receipts. The method also includes compiling second data indicative of a plurality of warehouse receipts. Each warehouse receipt includes at least one data field that does not substantially match a respective data field of at least one invoice. The method also includes identifying a first subset of data fields associated with the at least one invoice and comparing each data field of the first subset with a respective data field of each of the plurality of warehouse receipts. The method also includes determining a listing of warehouse receipts as a function of the data fields associated with a warehouse receipt that substantially match respective data fields of the first subset. The method further includes displaying the listing of warehouse receipts and identifying at least one of the plurality of warehouse receipts to be further evaluated by at least one operator.

### BRIEF DESCRIPTION OF THE DRAWINGS

FIG. 1 is a flow chart of an exemplary method for evaluating documents in accordance with the present disclosure; and

FIG. 2 is a schematic illustration of an exemplary work environment for performing the method of FIG. 1.

### DETAILED DESCRIPTION

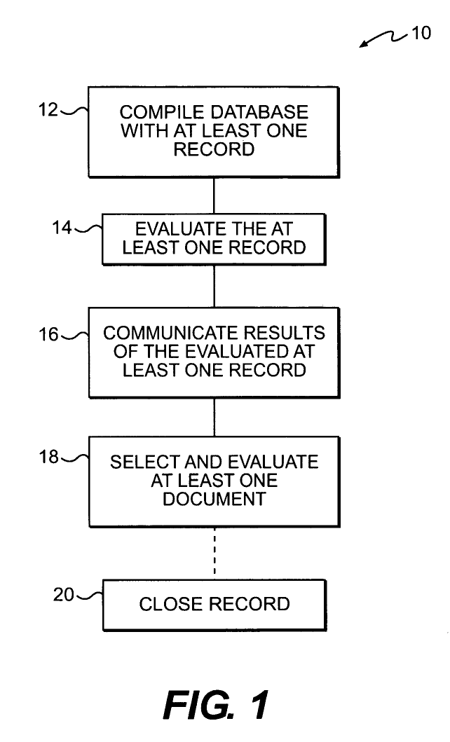

FIG. 1 illustrates an exemplary method 10 for evaluating documents. Method 10 may include compiling a database with at least one record, step 12. Method 10 may also include evaluating the at least one record, step 14, and communicating results of the evaluated record, step 16. Method 10 may also include selecting and evaluating at least one document, step 18 and may additionally include closing the record, step 20. It is contemplated that the steps associated with method 10 may be performed in any order and are described herein in a particular sequence for exemplary purposes only. It is also contemplated that method 10 may be performed continuously, periodically, singularly, as a batch method, and/or may be repeated as desired.

Step 12 may include compiling a database with at least one record. Specifically, step 12 may include populating a database with data indicative of at least one unmatched document associated with a system for procuring products. For example, step 12 may include a user inputting data into a database indicative of an invoice that does not substantially match, e.g., correspond to, a warehouse receipt. Step 12 may also include inputting data into the database indicative of data associated with one or more data fields of the unmatched document such as, for example, a purchase order number, a part number, a ship date, a supplier code number, a quantity, a reference number, and/or a packing list number. It is contemplated that the data indicative of the at least one unmatched document and/or of the one or more data fields may be identified by an external user, e.g., accounts payable personnel, and communicated to and populated within the database via an electronic communication. As such, step 12 may include compiling the database by receiving data from the external user. It is also contemplated that an unmatched document may include a document that has one or more data fields which do not substantially match a respective data field of at least one other document, e.g., a quantity of products associated with an invoice does not substantially match a quantity of products associated with any warehouse receipt. It is further contemplated that products may include any type or quantity of goods, e.g., parts or components, services, e.g., manipulations. or specific performances, and/or any other object that may be desired to be procured.

Step 14 may include evaluating the at least one record. Specifically, step 14 may include receiving data indicative of a criteria for a query, e.g., receive inputs from a user indicative of a search criteria, and performing a query as a function of the criteria. Step 14 may also include performing one or more algorithms configured to compare data of one or more data fields associated with the at least one record with data indicative of respective data fields associated with at least one other document as a function of the query. For example, step 14 may include comparing data indicative of one or more data fields of an invoice, e.g., data indicative of a purchase order number, a part number, a ship date, a supplier code, a quantity, a reference number, and/or a packing list number, with data indicative of respective data fields of a plurality of warehouse receipts. Step 14 may further include a user identifying a subset of the one or more data fields, e.g., a supplier reference number and a packing list number, of an unmatched invoice and comparing data associated with the subset of data fields with data associated with respective data fields of a plurality of unmatched warehouse receipts. It is contemplated that the criteria for the query may be communicated via any suitable method, e.g., drop down menus, interactive text blocks, check boxes, object oriented interfaces, pre-programmed algorithms, and/or any other input method known in the art. It is contemplated that the data associated with the at least one other document may be stored within any suitable database and may be compiled via any suitable method known in the art, such as, for example, manual data entry.

Step 14 may compare data via any suitable logic method known in the art, such as, for example, Boolean or fuzzy logic. Boolean logic is well known in the art as a comparison methodology that includes, for example, “and”, “or”, “if” “not”, and/or other data modifiers, and, as such, is not further described. Similarly, fuzzy logic is well known in the art as a comparison methodology that includes, for example, determining character transpositions, typographical errors, and/or other algorithms to determine the percentage and/or degree of similarity between first and second data, and, as such, is not further described. It is contemplated that the degree of similarity may include any range or threshold and may establish that first data substantially matches second data, according to any desired degree of similarity such as, for example, a percentage match of bytes, e.g. 25%, series of matching bytes, e.g., first six bytes match, and/or any other desired degree of similarity. It is also contemplated that the data may be indicative of any type of information, may include any alpha, numeric, and/or symbolic text, and/or may include any suitable form for storage within a database such as, for example, bytes stored within an electronic database. It is further contemplated that the data may be compared via any combination of logic analysis, e.g., part Boolean and part fuzzy logic.

Step 16 may include communicating results of the evaluated at least one record. Specifically, step 16 may include communicating and/or displaying data indicative of the compared data fields. For example, step 16 may include communicating data indicative of a listing, e.g. a grouping, of warehouse receipts arranged with respect to any suitable criteria, such as, for example, a listing according to date of data entry, the degree of similarity between a given data field and a respective data field, the number of warehouse receipts that meet each of the query criteria, a single warehouse receipt determined, via a suitable algorithm, to likely be the one of the plurality of warehouse receipts that corresponds to the unmatched database, indicative of any other statistical or informational data and/or any combination thereof. It is contemplated that the listing may be searchable, e.g., as a function of a search criteria, and/or manipulated as a function of a hierarchal arrangement, e.g., numerically ranking warehouse receipts as a function of part numbers. It is also contemplated that step 16 may include communicating the results via any suitable method known in the art, such as, for example, display within a graphical user interface, via electronic mail, and/or in printed hardcopy documents. It is further contemplated that the results may be determined, identified, and/or associated with respect to one another via any suitable method and/or algorithm configured to identify patterns with respect to the results, when thresholds are exceeded, and/or identify any other result.

Step 18 may include selecting and evaluating at least one document. Specifically, step 18 may include identifying one of the plurality of documents within the listing and further evaluating the identified document. For example, step 18 may include identifying a warehouse receipt that, as a function of the results of the evaluation performed in step 14, may have a relatively high probability of being associated with the unmatched invoice, e.g., a warehouse receipt that includes the highest number of matching data fields with the unmatched invoice, a warehouse receipt having the highest number of matching data fields within fuzzy logic thresholds, any other suitable criteria, and/or combination thereof. It is contemplated that a user may identify and select a particular document from the listing as a function of the results, knowledge, experience, and/or any other suitable criteria and may input data into the database and/or an algorithm to identify the particular document. It is contemplated that the identified document may or may not be the document having the highest number of matching data fields with respect to the listing of documents.

Additionally, step 18 may further include a user comparing the at least one record and the at least one document to evaluate the degree of difference of data fields therebetween, identify discrepancies associated with data fields of the at least one record, communicate with other users regarding the validity of data, add data with respect to the at least one record, and/or perform any suitable method to further evaluate the data of data fields associated with the at least one document. It is contemplated that a discrepancy, e.g., a difference in quantity, may be identified with respect to the at least one record and the at least one document and that the discrepancy may be corrected by adding data with respect to the at least one record within a comment field to substantially match, e.g., to correlate, the data indicative of the at least one document quantity to substantially match the data indicative of the at least one record quantity. That is, the user may selectively authorize a credit or debit, e.g., accept a warehouse receipt quantity instead of requesting or returning goods, and may amend data within the database accordingly, e.g., add data within a comment field to indicate that an invoice quantity should be paid with respect to the warehouse quantity and the debit or credit. It is also contemplated that the identified document may be further evaluated and determined to not substantially match the at least one record and that all of the data associated with the identified document is correct. As such, a user may identify another document, e.g., the different listed document, and evaluate the other identified document, and/or steps 14, 16, and 18 may be repeated with new query criteria to establish a second listing and identify another document to be further evaluated.

Step 20 may include closing the record. Specifically, step 20 may include identifying and/or tagging the at least one record as being no longer unmatched and communicating the at least one record to a downstream operator, e.g., an accounts payable department, for further processing, e.g. payment of the invoice to a supplier. It is contemplated that step 20 may include archiving, copying, and/or erasing the at least one record from the database. It is also contemplated that step 20 may include communicating with a downstream user via, for example electronic mail, to indicate that the at least one record no longer has one or more data fields which do not substantially match a respective data field of at least one other document, e.g., to indicate that an invoice substantially matches a warehouse receipt.

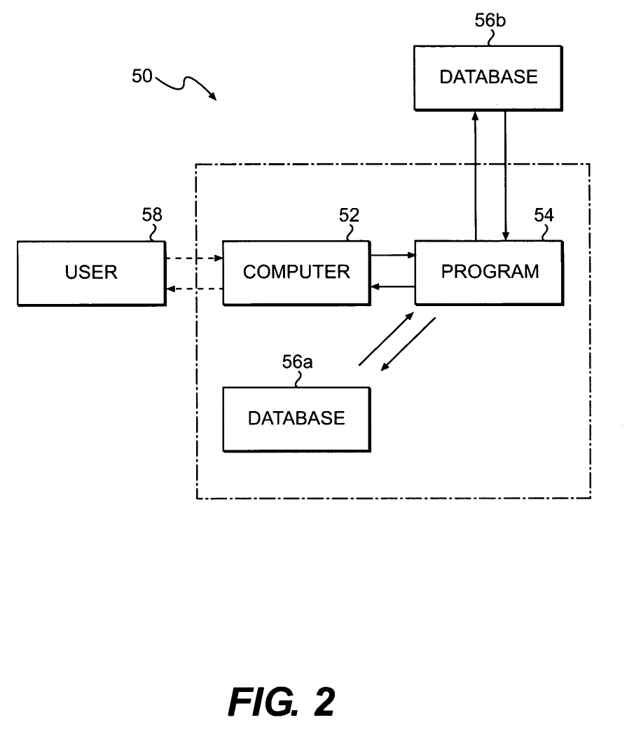

FIG. 2 illustrates an exemplary work environment 50 for performing method 10. Work environment 50 may include a computer 52, a program 54, and a first database 56a. Work environment 50 may be configured to accept inputs from user 58 via computer 52 to compare documents and may also be configured to communicate and/or display data or graphics to user 58 via computer 52. Work environment may also be configured to communicate with a second database 56b. It is contemplated that work environment 50 may include additional components such as, for example, a communications interface (not shown), a memory (not shown), and/or other components known in the art.

Computer 52 may include a general purpose computer configured to operate executable computer code. Computer 52 may include one or more input devices, e.g., a keyboard (not shown) or a mouse (not shown), to introduce inputs from user 58 into work environment 50 and may include one or more output devices, e.g., a monitor, to deliver outputs from work environment 50 to user 58. Specifically, user 58 may deliver one or more inputs, e.g., data, into work environment 50 via computer 52 to supply data to and/or execute program 54. Computer 52 may also include one or more data manipulation devices, e.g., data storage or software programs (not shown), to transfer and/or alter user inputs. Computer 52 may also include one or more communication devices, e.g., a modem (not shown) or a network link (not shown), to communicate inputs and/or outputs with program 54. It is contemplated that computer 52 may further include additional and/or different components, such as, for example, a memory (not shown), a communications hub (not shown), a data storage (not shown), a printer (not shown), an audio-video device (not shown), removable data storage devices (not shown), and/or other components known in the art. It is also contemplated that computer 52 may communicate with program 54 via, for example, a local area network (“LAN”), a hardwired connection, and/or the Internet. It is further contemplated that work environment 50 may include any number of computers and that each computer associated with work environment 50 may be accessible by any number of users for inputting data into work environment 50, communicating data with program 54, and/or receiving outputs from work environment 50.

Program 54 may include a computer executable code routine configured to perform one or more sub-routines and/or algorithms to compare documents within work environment 50. Specifically, program 54 may be configured to perform one or more steps of method 10. Program 54 may receive inputs, e.g., data, from computer 52 and perform one or more algorithms to manipulate the received data. Program 54 may also deliver one or more outputs, e.g., algorithmic results, and/or communicate, e.g., send electronic mail, to user 58 via computer 52. Program 54 may also access first and second databases 56a-b to locate and manipulate data stored therein to arrange and/or display stored data to user 58 via computer 52, e.g., via an interactive object oriented computer screen display. It is contemplated that program 54 may be stored within the memory (not shown) of computer 52 and/or stored on a remote server (not shown) accessible by computer 52. It is also contemplated that program 54 may include additional sub-routines and/or algorithms to perform various other operations with respect to mathematically representing data, generating or importing additional data into program 54, and/or performing other computer executable operations. It is further contemplated that program 54 may include any type of computer executable code, e.g., C++, and/or may be configured to operate on any type of computer software, e.g., IBM's Lotus® software.

First and second databases 56a-b may be configured to store and arrange data and to interact with program 54. Specifically, first database 56a may be configured to store and arrange data indicative of the at least one record compiled during step 12 (referring to FIG. 1). Second database 56b may be configured to store and arrange data indicative of one or more documents associated with a system for procuring products for comparing with the at least one record when evaluating the at leas tone record during step 14 (referring to FIG. 1). First and second databases 56a-b may store and arrange any quantity of data arranged in any suitable or desired format. Program 54 may be configured to access first and second databases 56a-b to identify particular data therein and display such data to user 58. It is contemplated that first and second databases 56a-b may include any suitable type of database such as, for example, a spreadsheet, a two dimensional table, or a three dimensional table, and may arrange and/or store data in any manner known in the art, such as, for example, within a hierarchy, in groupings according to associated documents, and/or searchable according to associated identity tags. It is also contemplated that second database 56b may be omitted and data indicative of the plurality of the one or more documents may be stored within first database 56a.

User 58 may include any entity configured to input data into and/or receive data from work environment 50. For example, user 58 may include a system manager configured to evaluate documents and/or other personnel associated with a system for procuring products, e.g., purchasers, schedulers, warehousemen, shippers, packers, accounts payable personnel, and/or any other entity associated with the procurement of products. For example, user 58 may populate first database 56a with data indicative of the at least one record and data associated with one or more data fields, evaluate the at least one record, and may, in conjunction with program 54, perform one or more steps of method 10. It is contemplated that user 58 may include any number of different entities that each may perform any number of different steps and/or actions within method 10.

### INDUSTRIAL APPLICABILITY

The disclosed system may be applicable to evaluate any type of documents. Specifically, the disclosed system may be applicable to evaluate a first document with respect to a plurality of second documents and further evaluate at least one second document to substantially match the first document. The description above and explanation below of method 10 is made with reference to a system for procuring products for exemplary purposes only, and it is noted that method 10 may be applicable to any type of system that includes unmatched documents.

Within a procurement system, e.g., a system associated with a company to order, receive, and issue payment for goods and/or services, one or more documents, e.g., warehouse receipts, warehouse receipts, invoices, and/or other documents known in the art, may be unmatched. For example, a company may receive an invoice from a supplier that does not substantially match a warehouse receipt. As such, the company may desire to resolve the unmatched invoice before issuing payment to the supplier. Often large companies purchase significant amounts of goods and services and create and receive significant amounts of warehouse receipts and invoices. Typically a company includes accounts payable personnel which manually resolve unmatched invoices, however, even if a small percentage of invoices are unmatched, because of the significant amount of invoices received, resolving unmatched invoices requires significant company resources.

Unmatched invoices and warehouse receipts may be identified by accounts payable personnel either manually or via one or more computer algorithms configured to match invoices with warehouse receipts. The unmatched invoices and warehouse receipts may be stored within one or more databases pending resolution. Referring to FIGS. 1 and 2, first database 56a may include data indicative of unmatched invoices and second database 56b may include data indicative of unmatched warehouse receipts. User 58, e.g., an operator, may access program 54 via computer 52 and perform method 10 to evaluate the invoice with respect to the warehouse receipts.

Specifically, user 58 may communicate one or more inputs, e.g. keystrokes and/or mouse clicks, into computer 52 that are configured to communicate inputs into program 54. The inputs may identify one of the unmatched invoices and query criteria with respect to one or more data fields operatively associated with the unmatched invoice. For example, user 58 may communicate inputs to identify a first unmatched invoice and identify a supplier reference number data field and a packing list number data field to be evaluated with respective data fields operatively associated with the one or more unmatched warehouse receipts. Additionally, user 58 may input logic operators to selectively relate the supplier reference number and the packing list number data fields. For example, user 58 may establish boolean logic adapted to identify warehouse receipts that include respective data fields that substantially match both the supplier reference number and packing list number data fields, e.g., a boolean “and” operator. For another example, user 58 may establish fuzzy logic adapted to identify warehouse receipts that include supplier reference numbers having n−1 of n numerals that match, e.g., a fuzzy logic operator that compares respective numerals within the supplier code number and identifies when the compared numerals match.

User 58 may then execute one or more algorithms within program 54 to perform the query as a function of the inputted criteria (step 14). For example, user 58 may perform a keystroke to execute an interactive oriented object to run program 54. As such, program 54, via one or more algorithms, may access second database 56b and identify one or more warehouse receipts that meet the criteria. Program 54 may also perform one or more algorithms to arrange the identified warehouse receipts within a listing as a function of the criteria (step 16). For example, program 54 may list identified warehouse receipts according to any desired arrangement and/or rationale. It is contemplated that user 58 may manipulate and/or search the list of warehouse receipts by, for example, performing an algorithm to identify warehouse receipts having a particular part number or numerically rank the warehouse receipts with respect to part numbers.

User 58 may identify a warehouse receipt for further evaluation (step 18). User 58 may further evaluate the identified warehouse receipt by resolving the data fields thereof that do not substantially match respective data fields of the unmatched invoice. For example, the query may identify one warehouse receipt that includes a supplier reference number and a packing list number that match respective data fields of the unmatched invoice. As such, user 58 may compare additional data fields, e.g., purchase order number, ship date, supplier code number, quantity, and/or part number to determine which of the data fields do not substantially match. User 58 may also directly amend data and/or identify and communicate with additional users to evaluate and amend data with respect to one or more data fields to substantially match all respective data fields between the invoice and the warehouse receipt. That is, user 58 may add data with respect to the invoice to correlate the data with respect to the warehouse receipt. It is noted that in the example above, a plurality of warehouse receipts may meet the limited criteria, however, such criteria is set forth for explanatory purposes only and that in operation, the criteria may be established, adjusted, and/or repeated to identify a limited number of warehouse receipts to be further evaluated.

User 58 may communicate the now matched invoice and warehouse receipt to an accounts payable personnel and close the record (step 20). User 58 may archive the record of the previously unmatched invoice for a predetermined period of time and may delete the record from first database 56a. The accounts payable personnel may process the invoice and issue payment to the supplier. It is contemplated that user 58 may repeat method 10 as necessary to resolve additional unmatched invoices.

Because method 10 may include identifying a subset of the plurality of data fields associated with an unmatched document, e.g., an invoice, instead of identifying all of the plurality of data fields, processing time and resources may be reduced by eliminating unnecessary searches or comparisons. Additionally, because method 10 and, in particular, the query criteria may include boolean and/or fuzzy logic, a less complex evaluation method may be provided.

It will be apparent to those skilled in the art that various modifications and variations can be made to the disclosed system for evaluating documents. Other embodiments will be apparent to those skilled in the art from consideration of the specification and practice of the disclosed method and apparatus. It is intended that the specification and examples be considered as exemplary only, with a true scope being indicated by the following claims and their equivalents.

What is claimed is:

1. A method for evaluating at least one document comprising:
compiling first data indicative of a first document, the first document including a plurality of first data fields;
receiving second data indicative of a first criteria, the first criteria including at least one of a quantity of first data fields to evaluate or a degree of required similarity with respect to a first data field to establish a match;
performing a first query as a function of the first criteria with respect to a first database, the first database populated with third data indicative of a plurality of second documents, each second document including a plurality of second data fields;
establishing fourth data indicative of a listing as a function of the second data fields each second document includes that substantially match a respective first data field; and
identifying as a function of the listing at least one of the plurality of second documents to be further evaluated with respect to at least one second data field associated with the identified second document.

2. The method of claim 1, wherein:
the first criteria is further configured to identify a first type of data field;
the at least one first document and the plurality of second documents each having at least one data field configured as the first type of data field; and
performing the first query includes comparing the first type data field associated with the at least one first document and the first type data field associated with at least one of the plurality of second documents.

3. The method of claim 2, wherein a data field associated with the at least one first document substantially matches a data field associated with at least one of the plurality of second documents if data associated with the at least one first document matches data associated with the at least one of the plurality of second documents within the required degree of similarity.

4. The method of claim 1, wherein:
the first criteria includes criteria indicative of at least one of boolean logic with respect to the quantity of first data fields or fuzzy logic with respect to the degree of required similarity;
the fuzzy logic includes the required degree of similarity; and
performing the query includes applying the at least one of boolean logic or fuzzy logic.

5. The method of claim 1, wherein the plurality of first data fields includes data indicative of at least one of a purchase order number, a part number, a ship date, a supplier code, a part quantity, or a packing list number.

6. The method of claim 1, further including:
establishing fifth data as a function of a degree of similarity between a first data field associated with the at least one first document and at least one respective second data field associated with at least one of the plurality of second documents.

7. The method of claim 1, wherein identifying as a function of the listing at least one of the plurality of second documents includes performing one or more algorithms configured to search the listing.

8. A work environment for evaluating a first document having a plurality of first data fields with respect to a plurality of second documents each having at plurality of second data fields comprising:
a computer configured to receive inputs from at least one user;
a database populated with first data indicative of the plurality of second documents; and
a program configured to:
receive a first input indicative of the first document,
receive a second input indicative of a first query including criteria configured to identify at least one first data field and a similarity threshold for the identified first data field,
perform at least one first algorithm as a function of the received first query, the first algorithm configured to access at least a portion of the first data to identify a subset of the plurality of second documents, each second document of the subset including at least one data field substantially similar to at least one data field of the first document, and
perform at least one second algorithm configured to establish the subset in a listing as a function of second data fields each second document includes that substantially match respective first data fields.

9. The work environment of claim 8, wherein:
the criteria configured to identify at least one first data field is configured to identify a group of first data fields and a similarity threshold for each first data field of the group of first data fields;
the group of first data fields includes fewer first data fields then the plurality of first data fields; and
establishing the subset in a listing includes arranging the subset as a function of the group of first data fields and the similarity threshold for each first data field.

10. The work environment of claim 8, wherein:
the criteria configured to identify at least one first data field is configured to identify a group of first data fields;
the second input includes a plurality of second inputs configured to identify the group of first data fields; and
the program is further configured to compare each first data field of the group of first data fields with a respective second data field of each of the plurality of second documents.

11. The work environment of claim 8, wherein:
the criteria configured to identify at least one first data field is configured to identify a group of first data fields and at least one boolean logic operator operatively associating the group of first data fields; and
the program is further configured to perform a third algorithm configured to perform boolean logic as a function of the criteria.

12. The work environment of claim 8, wherein
the criteria configured to identify a similarity threshold for the identified first data field is configured to identify at least one fuzzy logic operator operatively associating the first data field; and
the program is further configured to perform a third algorithm configured to perform fuzzy logic as a function of the criteria.

13. The work environment of claim 8, wherein the at least one first document and each of the plurality of second documents include a data field having data indicative of at least one of a purchase order number, a part number, a ship date, a supplier code, a part quantity, a reference number, or a packing list number.

14. The work environment of claim 8, wherein the at least one document is an electronically stored invoice and each of the plurality of second documents is an electronically stored warehouse receipt.

15. A method of matching an invoice having a plurality of data fields with a warehouse receipt having a plurality of data fields comprising:
compiling first data indicative of at least one invoice, the at least one invoice including at least one data field that does not substantially match a respective data field of at least one of a plurality of warehouse receipts;
compiling second data indicative of a plurality of warehouse receipts each of which include at least one data field that does not substantially match a respective data field of at least one invoice;
identifying a first subset of data fields associated with the at least one invoice;
comparing each data field of the first subset with a respective data field of each of the plurality of warehouse receipts;
determining a listing of warehouse receipts as a function of the data fields associated with a warehouse receipt that substantially match respective data fields of the first subset;
displaying the listing of warehouse receipts; and
identifying at least one of the plurality of warehouse receipts to be further evaluated by at least one operator.

16. The method of claim 15, wherein identifying at least one of the plurality of warehouse receipts includes performing an algorithm configured to search the listing and identify the quantity of the plurality of warehouse receipts that substantially match a search criteria.

17. The method of claim 15, wherein identifying a first subset of data fields includes establishing boolean logic to operatively associate the respective data fields of the first subset.

18. The method of claim 15, wherein comparing each data field of the first subset with a respective data field of each of the plurality of warehouse receipts includes applying fuzzy logic to determine if a degree of similarity between a first data field and a respective second data field.

19. The method of claim 15, wherein the plurality of data fields of the invoice and the plurality of data fields of the warehouse receipt each include data indicative of at least a purchase order number, a part number, a ship date, a supplier code, a part quantity, a reference number, or a packing list number.

20. The method of claim 15, further including adding data with respect to at least one of the plurality of data fields of the invoice.
